(19) United States
(12) Patent Application Publication
(10) Pub. No.: US 2025/0245717 A1
(43) Pub. Date: Jul. 31, 2025

(54) SYSTEMS AND METHODS FOR USING MACHINE-LEARNING TO DETERMINE USER-SPECIFIC GUIDANCE

(71) Applicant: Capital One Services, LLC, McLean, VA (US)

(72) Inventors: Camilo VARGAS-CABRERA, Arlington, VA (US); Julian DUQUE, Arlington, VA (US); Anibal RIVERA-VELAZQUEZ, Oxon Hill, MD (US)

(73) Assignee: Capital One Services, LLC, McLean, VA (US)

(21) Appl. No.: 18/422,664

(22) Filed: Jan. 25, 2024

(51) Int. Cl. G06Q 30/0601

(52) U.S. Cl. CPC G06Q 30/0631

(57) ABSTRACT

A method for using machine-learning to determine user-specific guidance may include receiving one or more item-level reports from one or more users. Individual item data of each of the one or more item-level reports may be determined. In response to determining that a trigger condition has been satisfied, a user data process may be performed, including transmitting an item-level report associated with the unique user, or identifying prior item-level data from an account associated with the unique user. Data obtained by the user data process and the individual item data may be provided to a machine-learning model. The machine-learning model may output guidance for the unique user. The guidance for the unique user may be transmitted to at least one computing device associated with the unique user.

### TECHNICAL FIELD

Various embodiments of this disclosure relate generally to machine-learning-based techniques for determining associations between data, and, more particularly, to systems and methods for determining guidance for a user.

### BACKGROUND

Users (e.g., consumers) are generally motivated to visit more than one entity (e.g., retailer, merchant, or vendor) to find the best price or most convenient location to purchase their desired item(s) (e.g., product(s), service(s), or combinations of product(s) and service(s)). Finding the entity with the best price on an item, or at more convenient location, can translate into time and money saved by the user, less emissions caused due to requiring less travel, and/or a reduction in resources required to maintain a listing of to-be-acquired items. However, resources (e.g., processing or compute resources, time, and effort) required by a user to research and identify an entity may quickly outweigh any benefit seen by the user trying to make such a determination on their own. Additionally, it would be virtually impossible for the user to check every entity to find the best option. Further, relying on word-of-mouth, or advertisements, to gather as much data as possible is likewise inefficient and may not fully appreciate all the options that may be available to the user. Still further, each user must be able to efficiently gather data unique to them to help inform the best choice. Budget, purchase preferences or history, item preferences, and/or willingness to travel a certain distance for the best option, may each be factors in determining what the best choice may be for each particular user.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for determining guidance for a user.

In one aspect, an exemplary embodiment of a method for using machine-learning to determine user-specific guidance may include receiving one or more item-level reports from one or more users. The method may further include determining individual item data of each of the one or more item-level reports. The method may further include, in response to determining that a trigger condition has been satisfied, a user data process may be performed, including transmitting an item-level report associated with the unique user, or identifying prior item-level data from an account associated with the unique user. The method may further include providing the data obtained by the user data process and the individual item data to a machine-learning model. The machine-learning model may have been trained using (i) training item-level data, (ii) training account data, and (iii) training location data, to identify user-specific guidance and output guidance for the unique user. The method may further include outputting, by the machine-learning model, the guidance for the unique user based on the data obtained by the user data process and the individual item data. The method may further include transmitting the guidance for the unique user to at least one computing device associated with the unique user.

In another aspect, an exemplary embodiment of a system for using machine-learning to determine user-specific guidance may include a memory storing instructions and a processor operatively connected to the memory and configured to execute the instructions to perform operations. The operations may include receiving one or more item-level reports from one or more users. The operations may further include determining individual item data of each of the one or more item-level reports. The operations may further include, in response to determining that the trigger condition has been satisfied, a user data process may be performed. The operations may further include, providing the data obtained by the user data process and the individual item data to a machine-learning model. The machine-learning model may have been trained using (i) training item-level data, (ii) training account data, and (iii) training location data, to identify user-specific guidance and output guidance for the unique user The operations may further include outputting, by the machine-learning model, the guidance for the unique user based on the data obtained by the user data process and the individual item data. The operations may further include transmitting the guidance for the unique user to at least one computing device associated with the unique user.

In a further aspect, an exemplary embodiment of a method for determining guidance for a unique user may include determining that a trigger condition has been satisfied. In response to determining that the trigger condition has been satisfied, a user data process may be performed, including identifying item-level report data. The method may further include providing the data obtained by the user data process and the individual item data to a machine-learning model. The machine-learning model may have been trained using (i) training item-level data, (ii) training account data, and (iii) training location data, to identify user-specific guidance and output guidance for the unique user. The method may further include outputting, by the machine-learning model, the guidance for the unique user based on the data obtained by the user data process and the individual item data. The method may further include transmitting the guidance for the unique user to at least one computing device associated with the unique user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for using a machine-learning model to determine guidance for a user, according to one or more embodiments.

FIG. 2 depicts a flowchart of an exemplary method of determining guidance for a user, according to one or more embodiments.

FIG. 3 depicts an example of a computing device, according to one or more embodiments.

### DETAILED DESCRIPTION OF EMBODIMENTS

According to certain aspects of the disclosure, methods and systems are disclosed for determining guidance for a user, e.g., determining a recommended entity for an interaction (e.g., purchase). Users must be able to quickly determine the ideal entity to buy their frequently bought or desired items based on factors such as price, location, or the like. According to the present disclosure, guidance may be determined for a unique user by a machine-learning model trained to find associations between previous interactions the user has made, the current location of the user, user preferences, combinations thereof, and the like. In addition, crowdsourced data from entities and other users may be leveraged to further inform the machine-learning model to determine the unique guidance for each user. This guidance may therefore provide the user with the entity where the user is most likely to find the best options for the desired items according to factors unique to each user.

As will be discussed in more detail below, in various embodiments, systems and methods are described for using machine-learning to determine guidance for a user. By training a machine-learning model, e.g., via supervised or semi-supervised learning, to learn associations between item level data, e.g., data from a purchase receipt, and user purchase data and location data, the trained machine-learning model may be usable to determine a recommended entity. The computational complexity of formulating unique guidance for a unique user, in a given unique situation, given vast sets of item level data, user purchase data, and location data, may therefore be made possible by the use of the machine-learning techniques described herein.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” may mean “based at least in part on.” The singular forms “a,” “an,” and “the” may include plural referents unless the context dictates otherwise. The term “exemplary” may be used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompass any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software. As used herein, terms such as “guidance” or the like generally encompass one or more recommendations.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a machine-learning model may determine guidance for a user. In such examples, the guidance may be presented to a user, e.g., via a computing device associated with the user, as a recommendation for a particular entity from which a user may purchase an item that the user desires.

In another exemplary use case, a machine-learning model may be trained to find associations between item level data (e.g., from a purchase receipt) and user preferences, pricing, location, and crowdsourced data in order to determine guidance for a user.

In another exemplary use case, a large number of receipts representing interactions of a large number of users may be received by a user guidance system and item level data may be extracted from the receipts. In response to a trigger condition (e.g., a change in a user's location, a purchase being made, or the like, as described in more detail below), a user data process may be performed by requesting a receipt from the user or by accessing prior purchase data of the user to extract item level data. The item level data of the user data process and the item level data from the large number of receipts may then be input into a machine-learning model. The machine-learning model may then find associations within the input data and output guidance unique to the user's history, current needs, and current situation (e.g., location).

While several of the examples above involve determining guidance for a user, it should be understood that techniques according to this disclosure may be adapted to any suitable type of determining guidance for a user. It should also be understood that the examples above are illustrative only. The techniques and technologies of this disclosure may be adapted to any suitable activity.

Presented below are various aspects of machine-learning techniques that may be adapted to determining guidance for a user. As will be discussed in more detail below, machine-learning techniques adapted to determining guidance for a user, may include one or more aspects according to this disclosure, e.g., finding associations between a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

Budget conscious consumers may visit more than one retailer a week for groceries or other consumer products in order to find the best product that fits the needs of the consumer at the best price. At times, consumers may visit a number of different stores to find the best product at the best price. For a consumer, visiting a number of vendors may be highly inefficient or impractical. Further, for a consumer to gather enough marketing data (e.g., ads or flyers) to make the best purchasing decision may be unfeasible. Further, even if such information were readily available to the consumer, parsing that information in order to determine an optimal selection of a retailer or retailers to find the best product at the best price may be impractical or impossible. Reminiscent of the “travelling salesman problem,” determining guidance that would be helpful to the consumer via conventional means may be computationally nontrivial and/or impractical. In other words, the scenario above may represent a technical problem, e.g., in terms of computational complexity, data organization, and/or relationships between data that may be unintuitive, unknown, or complex. Conventionally, this technical problem may be impossible or impractical for a person to solve, even when aided by conventionally available resources.

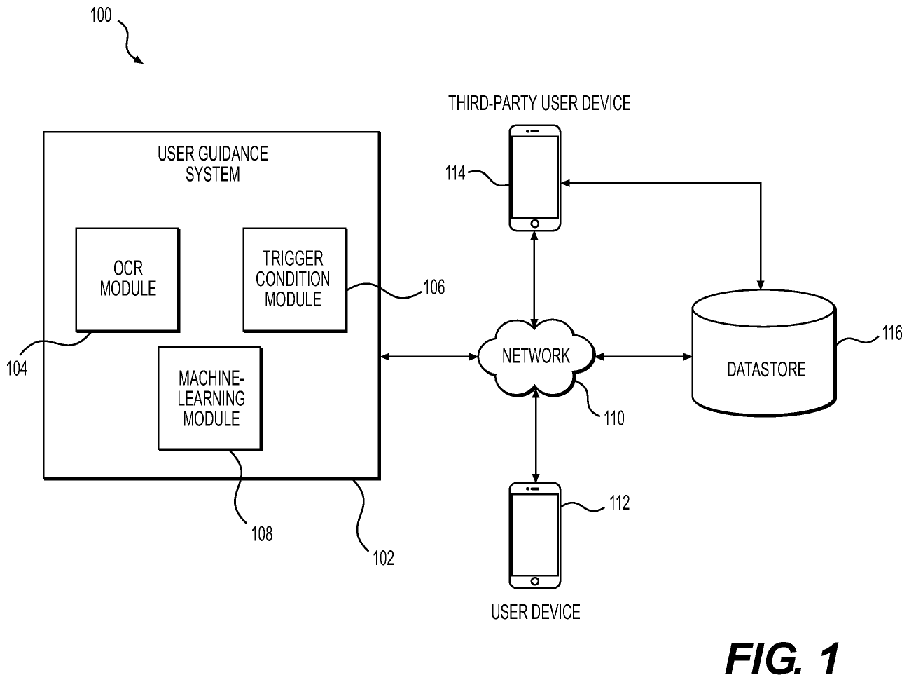

Consumers may therefore benefit from a technical solution to one or more issues such as those discussed above, e.g., a system and/or computer-implemented method that enables the consumer to quickly make decisions regarding where to purchase frequently bought or desired products. In embodiments, a system and/or method according to one or more aspects this disclosure may enable consumers to receive recommendations (e.g., guidance), the recommendations having been generated using a large amount of data from a large pool of consumers, not otherwise readily available to the particular consumer. The large amount of consumer data, related to the behaviors of those consumers, as wells as data gathered from the particular consumer, may be used by a machine-learning model to learn consumer preferences and/or behaviors based on purchases, decisions, and the like. Using machine-learning, the guidance, e.g., that may be impractical or impossible to produce using brute force techniques, may be generated. Further, the guidance output by the system, by using the machine-learning model, may improve with consistent retraining, using additional input data and past guidance. In other words, according to one or more aspects of this disclosure, particular training data used to specifically train a machine-learning model results in a trained model that is specifically tuned to addressing one or more of the difficulties discussed above, as well as others. In various embodiments, user devices (e.g., mobile devices), point-of-sale devices, servers, data stores, and the like, as discussed below, may gather and provide the data input into the machine-learning model for training and/or execution of the described methods. Each component may also communicate with a user guidance system across an electronic network to implement the systems and methods described herein, which will be discussed below with respect to FIGS. 1-3.

FIG. 1 depicts an exemplary environment 100 that may be utilized with techniques presented herein. One or more user device(s) 112 may communicate across an electronic network 110. The one or more user device(s) 112 may be associated with a user, e.g., a user for which guidance may be determined and/or provided. As will be discussed in further detail below, one or more user guidance system(s) 102 may communicate with one or more of the other components of the environment 100 across electronic network 110. In addition, one or more third-party user device(s) 114 may communicate with user guidance system(s) 102 across electronic network 110. In some embodiments, the third-party user device(s) 114 may transmit one or more item-level reports (e.g., of one or more interactions, such as purchase or transaction receipts) from one or more third-party users to user guidance system(s) 102 across electronic network 110.

The user device(s) 112 may be configured to enable a user to access and/or interact with other systems in the environment 100. Likewise, the third-party user device(s) 114 may be configured to enable a third-party user to access and/or interact with other systems in the environment 100. For example, the user device(s) 112 and third-party user device(s) 114 may each be a computer system such as, for example, a desktop computer, a mobile device, a tablet, etc. In some embodiments, the user device(s) 112 and/or the third-party user device(s) 114 may include one or more electronic application(s), e.g., a program, plugin, browser extension, etc., installed on a memory of the user device(s) 112 or third-party user device 114, respectively. In some embodiments, the electronic application(s) may be associated with one or more of the other components in the environment 100. For example, the electronic application(s) may include one or more of system control software, system monitoring software, software development tools, etc.

In various embodiments, the environment 100 may include a datastore 116 (e.g., database). The datastore 116 may include a server system and/or a data storage system such as computer-readable memory such as a hard drive, flash drive, disk, etc. In some embodiments, the datastore 116 includes and/or interacts with an application programming interface for exchanging data to other systems, e.g., one or more of the other components of the environment. The datastore 116 may include and/or act as a repository or source for storing one or more item-level reports from one or users (e.g., a user of user device 112) or one or more third-party users (e.g., a user of third-party user device 114) and/or individual item level data of each of the one or more item-level reports. For example, the item level data of each of the one or more item-level reports may be used by user guidance system(s) 102 to determine that a trigger condition has been satisfied, as discussed in more detail below.

In some embodiments, the components of the environment 100 are associated with a common entity, e.g., a financial institution, an account provider, or the like. For example, in some embodiments, user guidance system 102 and datastore 116 may be associated with a common entity. In some embodiments, one or more of the components of the environment is associated with a different entity than another. For example, user guidance system 102 may be associated with a first entity (e.g., a financial institution) while datastore 116 may be associated with a second entity (e.g., a storage entity providing storage services to the first entity). The systems and devices of the environment 100 may communicate in any arrangement. As will be discussed herein, systems and/or devices of the environment 100 may communicate in order to one or more of generate, train, or use a machine-learning model to determine guidance for a user, among other activities.

As discussed in further detail below, the user guidance system(s) 102 may one or more of (i) generate, store, train, or use a machine-learning model configured to determine guidance for a user. The user guidance system(s) 102 may include a machine-learning model and/or instructions associated with the machine-learning model, e.g., instructions for generating a machine-learning model, training the machine-learning model, using the machine-learning model etc. The user guidance system(s) 102 may include instructions for retrieving item-level data, adjusting item-level data, and/or user account data, user preferences, and/or purchase history e.g., based on the output of the machine-learning model, and/or operating a display of the user device(s) 112 to output the guidance for the user, e.g., as adjusted based on the machine-learning model. The user guidance system(s) 102 may include training data, e.g., item-level data, and may include ground truth, e.g., (i) training item-level data, (ii) training account data, and (iii) training location data to identify guidance for a user data.

As depicted in FIG. 1, user guidance system(s) 102 may include optical character recognition (OCR) module 104. In various embodiments, OCR module 104 is configured to perform optical character recognition (OCR) on one or more item-level reports. In examples, the one or more item-level reports may be uploaded to user device(s) 112 and/or third-party user device(s) 114. In examples, the uploading may be done via an input device of user device(s) 112 and/or third-party user device(s) 114, such as a camera, sensor, or the like, and as described herein. The data gathered from the uploaded item-level reports may then be transmitted via electronic network 110 to user guidance system 102, and provided to machine-learning module 108 as input. In various embodiments, machine-learning module 108 may be configured to receive, as input, the training data for the machine-learning model, as described above. For example, item-level data from one or more interactions, user account data, and user location data may be input into the machine-learning model of machine-learning module 108 as training data. Machine-learning module 108 may also be configured to output the trained machine-learning model as will be described in further detail below.

User guidance system(s) 102 may also include trigger condition module 106. In various embodiments, trigger condition module 106 may be configured to perform a user data process when a trigger condition has been satisfied. In examples, the trigger condition may be that a user interaction has taken place (e.g., a purchase has been made). In other examples, a request for guidance by the user, an update to the user account and/or profile, a change in user location, or the like, may satisfy the trigger condition. The user data process may include sending a data packet to user device(s) 112. In examples, the data packet may include a request to transmit an item-level report associated with the user or may identify prior item-level data from an account associated with the user (e.g., an account associated with an entity associated with user guidance system 102). In various embodiments, the user data process performed by the trigger condition module 106 may aid the process of the machine-learning module to determine, via a trained machine-learning model, guidance for the user.

In some embodiments, a system or device other than the user guidance system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the user guidance system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between user item-level data and crowdsourced item-level data, such that the trained machine-learning model is configured to determine an output of guidance for a user in response to the input item-level data based on the learned associations.

In various embodiments, the variables of a machine-learning model may be interrelated in any suitable arrangement in order to generate the output. For example, in some embodiments, the machine-learning model may include image-processing architecture that is configured to identify, isolate, and/or extract features, geometry, and or structure in one or more of the optical character recognition data and/or the non-optical in vivo image data. For example, the machine-learning model may include one or more convolutional neural network (“CNN”) configured to identify features in the item-level report data, and may include further architecture, e.g., a connected layer, neural network, etc., configured to determine a relationship between the identified features in order to determine a location in the item-level report data.

In some instances, different samples of training data and/or input data may not be independent. For example, samples of training data may include multiple item-level reports from third-party users, as well as data sets from vendors and one or more user accounts. Thus, in some embodiments, the machine-learning model may be configured to account for and/or determine relationships between multiple samples.

For example, in some embodiments, the machine-learning model of the user guidance system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of non-optical in vivo images as input, and generate a sequence of locations, e.g., a path, in the item-level report data as output.

In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the user guidance system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to provide guidance to a user are discussed in further detail in the methods below. In the following methods, various acts may be described as performed or executed by a component from FIG. 1, such as the user guidance system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

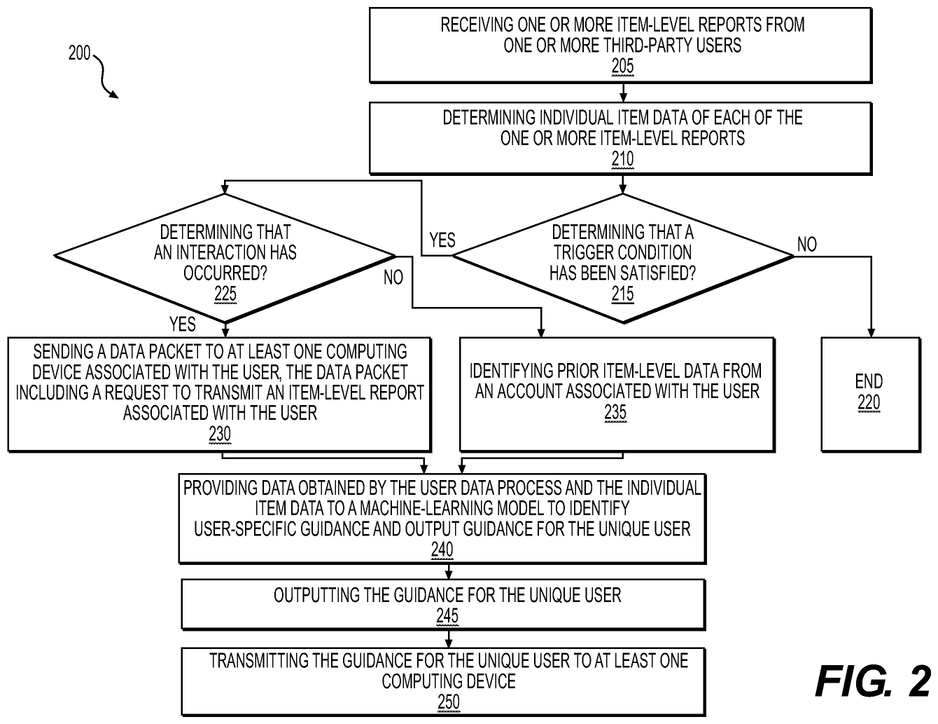

FIG. 2 illustrates an exemplary method 200 for using machine-learning to determine user-specific guidance (e.g., recommendations), such as in the various examples discussed above. At step 205, one or more item-level reports (e.g., of one or more interactions, such as purchase receipts, transaction records, transaction history, account information and the like) from one or more third-party users (e.g., consumers) is received. The one or more item-level reports may be received by one or more processors, such as that of third-party user device 114 and/or user device 112 and/or user guidance system 102. The one or more item-level reports may also be transmitted to user guidance system 102 by any of the components in environment 100, such as, for example, by third-party user device 114 via network 110. The one or more item-level reports may be transmitted using one or more third-party user devices, such as third-party user device 114 as depicted in FIG. 1. In examples, the third-party users may be within a geographic boundary relative to the user for which the guidance is determined (e.g., using global positioning (GPS) or geofencing data received from the third-party user device 114), and/or the third-party users may be individuals whose purchase histories, patterns, or preferences are similar to that of the user. In such cases, prior to or after receiving the one or more item-level reports at step 205, the method 200 may include the optional steps of (1) determining a geographic location of a user and a geographic location of one or more third-party users (e.g., via a GPS sensor of the user device 112 or third-party user device 114, respectively), (2) determining whether the geographic location of the third-party users is within a threshold distance of the user, and (3) identifying a subset of the item-level reports from the one or more third-party users within the threshold distance of the user. It is understood that the threshold distance may be a criteria established by the user guidance system 102 (e.g., based on anticipated or expected distances travelled by users in a specified geographic area), or selected by a user of user device 112. Additionally or alternatively, prior to or after receiving the one or more item-level reports at step 205, the method 200 may include the optional steps of (1) examining a purchase history, patterns, or preferences of a user of user device 112, (2) examining a purchase history, patterns, or preferences of one or more third-party users of third-party user devices 114, and (3) identifying a subset of the item-level reports from the one or more third-party users having a threshold degree of overlap between the purchase history, patterns, or preferences of the user of the user device 112 and that of the third-party users of third-party user devices 114. It is understood that the threshold degree of overlap may be a criteria established by the user guidance system 102 or selected by a user of user device 112. In examples, such data may be analyzed to determine associations between the data and data of the user's account or profile, or preferences set by the user. In various embodiments, the machine-learning model may make determinations as to the relevance of the data of a particular third-party user(s) to a particular user.

At step 210, individual item data of each of the one or more item-level reports is determined. In examples, this may be done by performing optical character recognition (OCR) on the one or more item-level reports received at step 205. The OCR may be performed using a component of a user guidance system, such as OCR module 104 depicted in FIG. 1. In other examples, individual item data of the one or more item-level reports may be determined by a fillable form filled out by a user, an uploaded document, an email with the item-level report attached, or by gathering the item-level reports via a third-party system, such as a user account, financial system, retail system, banking or purchase transactions, or the like. In examples, the individual item data may include at least one of an item identifier, a cost, a vendor identifier, a time, a date, or a location. In examples, the individual item data may be stored in a storage system, such as data store 116 depicted in FIG. 1. In this way, the individual item data may be stored and retrieved by user guidance system 102 or any other component of environment 100.

At step 215, it is determined if a trigger condition has been satisfied. In examples, a component of user guidance system 102 as depicted in FIG. 1 determines if such trigger condition has been satisfied, such as trigger condition module 106 as depicted in FIG. 1. In various embodiments, the trigger condition may include identifying a user request for the guidance or predicting a future interaction (e.g., an imminent purchase) by the user. In examples, predicting the future interaction may be based on a timing or location of a prior purchase made by the user. In one particular example, the user's account may indicate that the user purchases shampoo every two months; therefore, as the next two-month mark approaches, the trigger condition may be satisfied (e.g., it is determined that a user may purchase shampoo imminently). The user's account may be a bank account, a user profile, a credit account, or the like. In examples, such accounts may be associated with an entity that is associated with user guidance system 102. In examples, determining that the trigger condition has been satisfied may include identifying a user request for guidance (e.g., the user requests a recommendation for a particular item). In examples, the user may request guidance using a software module, application programming interface, or the like, associated with user guidance system 102 and stored in a memory of user device 112 and executed by a processor of user device 112. If the trigger condition has not been satisfied, at step 220, exemplary method 200 ends. If, however, a trigger condition has been satisfied, at step 225, it is determined if an interaction has occurred. In either case, a user data process is performed in response to determining that the trigger condition has been satisfied.

If an interaction has occurred, the user data process may include sending a data packet to at least one computing device associated with the user (e.g., sending via user guidance system 102 over electronic network 110 to user device 112), as illustrated at step 230, or, if an interaction has not occurred, prior item-level data is identified (e.g., purchase history, preferences, or the like) from an account associated with the user, as illustrated at step 235. In the case that a data packet is sent, the data packet may include a request to transmit an item-level report associated with the user (e.g., a request to upload a purchase receipt). In examples, the user may then, in response to this request, manually upload the item-level report using a user device. In one example, the request may be sent as a push notification to a user device, such as user device 112 depicted in FIG. 1. In various embodiments, a generated incentive (e.g. a reduction or the like) may then be transmitted to the user device based upon a response from the user to the request to transmit an item-level report associated with the user. In such examples, the user receives an incentive in exchange for providing additional data that may be used to retrain the machine-learning model. In a particular example, the incentive may be a coupon for an item or service, user account status (e.g., associating the user account with a “top contributor” status), unlocking additional features or services of the user guidance system, to receive the guidance, and the like. In other examples, a generated incentive may be transmitted to the user device based upon an accumulation of responses, or more than one response, such as a current response and a past response. In such examples, when a single response may not meet a set of criteria to trigger the incentive, multiple, accumulated, responses may be used to determine if an incentive may be generated, how close a user is to receiving the incentive, or the like.

Subsequent to the user data process being performed, at step 240, the data obtained from the user data process and the individual item data is provided to a machine-learning model. A machine-learning module, such as machine-learning module 108 depicted in FIG. 1, may utilize the machine-learning model. The machine-learning model may identify user-specific guidance and output guidance for the unique user. In examples, determining the guidance for the user is based upon a set of criteria. Therefore, the set of criteria may be provided as input to the machine-learning model. In this way, a recommendation that identifies a particular vendor or vendors may be determined for the user based upon the user's habits, type of item desired, location of the user or the desired items, and/or the price of the desired items. The criteria may be set by the user or may be set by one or more components of user guidance system 102, such as machine-learning module 108. In examples, determining such guidance may provide a means to help the user to identify the most efficient (e.g., least time intensive or costly) way in which to obtain the desired item(s). In other examples, the guidance (e.g., recommendations) may be filtered by the user. The user may select filters that eliminate or select guidance based on the user's location, a desired brand name, a preferred store, vendor, or merchant, a cost of item identified by the guidance, and the like. A machine-learning model may also apply filters to the guidance before presenting the guidance to a user.

The machine-learning model may be trained using (i) training item-level data, (ii) training account data, and (iii) training location data. In examples, the training data may be simulated and/or gathered, such as via one or more item-level reports from third-party users and/or item-level reports associated with the unique user and/or account data of the unique user. In examples, the machine-learning model, having been trained using data gathered from third party users, may find associations between the third party user data (e.g., one or more item-level reports) and data specific to the unique user such as an item-level report and/or account data. In various embodiments, the user-specific guidance may be input into the machine-learning model as training data to retrain the machine-learning model. In such examples, whether or not the user's next subsequent purchase aligns with the guidance given by the system may also be input into the machine-learning model to retrain the machine-learning model.

At step 245, the machine-learning model may output the guidance for the unique user based on the data obtained by the user data process and the individual item data. Finally, at step 250, the guidance may be transmitted to the at least one computing device (e.g., user device 112 depicted in FIG. 1) associated with the unique user. In various embodiments, the guidance may be output to a user interface (e.g., of a computing device) and may allow user interaction with the guidance, such as the option to purchase the item through an entity via an online platform, requesting driving directions to a location of the entity to purchase the item, and the like. In other examples, the guidance may be automatic, such as adding an item to a digital shopping cart. Such automatic guidance may be provided if the user has given enough input previously so that the guidance may be relevant to the user.

In one particular example of providing a recommendation to a particular user (e.g., consumer), the user may wish to purchase a home appliance, such as a toaster. Multiple purchase receipts from third-party users may be parsed to obtain the data pertaining to items purchased, price of the items, and location and/or vendor, and the like. As these purchase receipts are parsed using OCR, data related to the purchase of toasters may be collected, among other data. In this example, the user guidance system (e.g., user guidance system 102 as depicted in FIG. 1) then determines that either the user has requested a recommendation of where to purchase a toaster, or that the user is about to purchase a toaster. The user guidance system may also identify prior purchase patterns or habits of the user based upon a purchase history associated with the user's profile and/or account. The user guidance system then, using a machine-learning model, determines and presents the user with a recommendation of where to purchase the toaster and/or presenting the user with an estimated price of the toaster. In various examples, the recommendation may be based upon the user's location (e.g., proximity to a vendor location), purchase preferences or habits (e.g., brand preference), and price (e.g., finding the best price using the data obtained from the third-party purchase receipts related to toasters).

It should be understood that embodiments in this disclosure are exemplary only, and that other embodiments may include various combinations of features from other embodiments, as well as additional or fewer features. For example, while some of the embodiments above pertain to determining guidance for a user, any suitable activity may be used. In an exemplary embodiment, instead of or in addition to determining guidance for the user, the user guidance system may include identifying a user request for the guidance and/or predicting a future interaction of the user.

In general, any process or operation discussed in this disclosure that is understood to be computer-implementable, such as the process illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

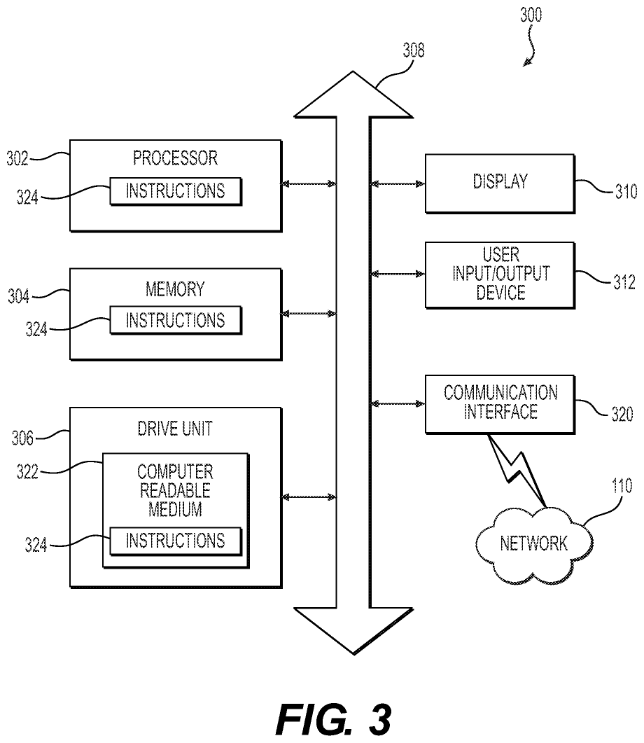

FIG. 3 is a simplified functional block diagram of a computer 300 that may be configured as a device for executing the method of FIG. 2, according to exemplary embodiments of the present disclosure. For example, the computer 300 may be configured as the user guidance system 102 and/or another system according to exemplary embodiments of this disclosure. In various embodiments, any of the systems herein may be a computer 300 including, for example, a data communication interface 320 for packet data communication. The computer 300 also may include a central processing unit (“CPU”) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 and/or computer readable medium 322). The computer 300 also may include input and output ports 312 and/or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for using machine-learning to determine user-specific guidance, comprising:
receiving one or more item-level reports from one or more users;
determining individual item data of each of the one or more item-level reports;
in response to determining that a trigger condition has been satisfied, performing a user data process, including:
receiving an item-level report associated with a unique user; or
identifying prior item-level data from an account associated with the unique user;
providing, by one or more processors, data obtained by the user data process and the individual item data to a machine-learning model, wherein the machine-learning model has been trained, using (i) training item-level data, (ii) training account data, and (iii) training location data, to identify user-specific guidance and output guidance for the unique user;
outputting, by the machine-learning model, the guidance for the unique user based on the data obtained by the user data process and the individual item data; and
transmitting the guidance for the unique user to at least one computing device associated with the unique user.

2. The computer-implemented method of claim 1, wherein the guidance for the unique user is input into the machine-learning model as training data to retrain the machine-learning model.

3. The computer-implemented method of claim 1, further comprising:
determining that the trigger condition has been satisfied, comprising identifying a user input for the guidance.

4. The computer-implemented method of claim 1, further comprising:
determining that the trigger condition has been satisfied, comprising predicting a future interaction of the unique user.

5. The computer-implemented method of claim 4, wherein predicting the future interaction is based on a timing or location of a prior interaction of the unique user.

6. The computer-implemented method of claim 1, wherein the individual item data comprises at least one of an item identifier, a cost, an entity identifier, a time, a date, or a location.

7. The computer-implemented method of claim 1, further comprising:
providing, by one or more processors, a set of criteria to the machine-learning model.

8. The computer-implemented method of claim 1, further comprising:
transmitting a generated reduction to at least one computing device associated with the unique user based upon a response from the unique user to a transmission of the item-level report associated with the unique user.

9. A system for using machine-learning to determine user-specific guidance, comprising:
a memory storing instructions and a processor operatively connected to the memory and configured to execute the instructions to perform operations including:
receiving one or more item-level reports from one or more users;
determining individual item data of each of the one or more item-level reports;
in response to determining that a trigger condition has been satisfied, performing a user data process;
providing, by one or more processors, data obtained by the user data process and the individual item data to a machine-learning model, wherein the machine-learning model has been trained, using (i) training item-level data, (ii) training account data, and (iii) training location data, to identify user-specific guidance and output guidance for a unique user;
outputting, by the machine-learning model, the guidance for the unique user based on the data obtained by the user data process and the individual item data; and
transmitting the guidance for the unique user to at least one computing device associated with the unique user.

10. The system of claim 9, wherein the guidance for the unique user is input into the machine-learning model as training data to retrain the machine-learning model.

11. The system of claim 9, wherein the user data process includes sending a data packet to the at least one computing device associated with the unique user.

12. The system of claim 9, wherein the user data process includes identifying prior item-level data from an account associated with the unique user.

13. The system of claim 9, wherein the trigger condition includes predicting a future interaction, and the predicting the future interaction is based on a timing or location of a prior interaction of the unique user.

14. The system of claim 9, wherein the individual item data is determined by performing optical character recognition on the one or more item-level reports, and wherein the individual item data comprises at least one of an item identifier, a cost, an entity identifier, a time, a date, or a location.

15. The system of claim 9, further comprising:
providing a set of criteria to the machine-learning model.

16. A computer-implemented method for using machine-learning to determine user-specific guidance, comprising:
determining that a trigger condition has been satisfied;
in response to determining that the trigger condition has been satisfied, performing a user data process, including identifying item-level report data;
providing, by one or more processors, data obtained by the user data process and individual item data to a machine-learning model, wherein the machine-learning model has been trained, using (i) training item-level data, (ii) training account data, and (iii) training location data, to identify user-specific guidance and output guidance for a unique user;
outputting, by the machine-learning model, the guidance for the unique user based on the data obtained by the user data process and the individual item data; and
transmitting the guidance for the unique user to at least one computing device associated with the unique user.

17. The computer-implemented method of claim 16, wherein the guidance for the unique user is input into the trained machine-learning model as training data to retrain the trained machine-learning model.

18. The computer-implemented method of claim 16, wherein determining that the trigger condition has been satisfied comprises identifying a user input for the guidance.

19. The computer-implemented method of claim 16, wherein determining that the trigger condition has been satisfied comprises predicting a future interaction of the unique user.

20. The computer-implemented method of claim 19, wherein predicting the future interaction is based on a timing or location of a prior interaction of the unique user.
